(19) United States
(12) Patent Application Publication
(10) Pub. No.: US 2016/0001386 A1
(43) Pub. Date: Jan. 7, 2016

(54) Electrochemical Machining Process

(71) Applicant: Harvest Precision Components, Inc., Williamsville, NY (US)

(72) Inventor: Richard B. McPhillips, Williamsville, NY (US)

(73) Assignee: HARVEST PRECISION COMPONENTS, INC., Williamsville, NY (US)

(21) Appl. No.: 14/796,132

(22) Filed: Jul. 10, 2015

Related U.S. Application Data
(63) Continuation of application No. 13/702,926, filed on Apr. 8, 2013, now abandoned.
(60) Provisional application No. 61/353,408, filed on Jun. 10, 2010.

(51) Int. Cl. B23H 3/08; B23H 3/04; B23H 3/00

(52) U.S. Cl. CPC B23H 3/08; B23H 3/00; B23H 3/04

(57) ABSTRACT

Electrochemical machining method and apparatus wherein in one aspect of the invention, the machining voltage is selected to maintain the highest current without initiating substantial hydrolysis of the electrolyte flushed between the work piece anode and tool cathode. In another aspect of the invention, the Low Machining Potential Voltage (LPMV) and High Machining Potential Voltage (HMPV) for a particular work piece material are identified and the work piece is machined using a voltage at or between the LMPV and HMPV. In yet another aspect of the invention, direct perturbation of the Beta Insulating Layer (BIL) is carried out in an optimally small (between about near zero to about 10μ) inter-electrode gap (IEG) with constant and simultaneous pulling in and pushing out of the electrolyte through the IEG.

### BACKGROUND OF THE INVENTION

The present invention relates generally to electrochemical machining (sometimes referred to as “ECM” herein) of a work piece, and more particularly relates to a novel method and apparatus for electrochemical machining of a work piece which represents a significant improvement over the present state of the electrochemical machining art.

Electrochemical machining of an electrically conductive work piece is well known and involves a conductive work piece to be machined (anode), a tool (cathode) which is positioned in non-contact, spaced relation to the work piece, and an electrolyte comprising an electrically conductive fluid such as NaCI in H₂0, for example, flushed between the tool and work piece. The distance or spacing between the anode and cathode is termed the inter-electrode gap or “IEG”. A voltage is applied between the work piece and the cathode whereupon an electric circuit is established between the work piece and the cathode through the electrolyte. With the cathode being continuously advanced toward the work piece and as ions cross the IEG, electrically conductive material (hereinafter “material”) is removed from the work piece as the atoms and molecules leave the work piece and enter into the electrolyte as ions and molecules and are flushed through the IEG. The removal of atoms and molecules from targeted areas of the work piece is what “machines” the work piece into the desired shape. The ECM process may thus be considered the opposite of electrochemical plating where material is added to a work piece through an electrolyte bath.

Besides the atoms and molecules which detach from the work piece material, including their oxides, additional particles formed during the ECM process accumulate in the IEG and are collectively termed “by-products of dissolution”. Although the exact by-products produced during ECM will vary depending on the type of work piece material and electrolyte being used in a particular application, examples of such by-products of dissolution include hydrogen and oxygen gas bubbles formed by hydrolysis of the water in the electrolyte, hydroxyl molecules and various stoichiometric phases of the metal particles with other molecules and atoms. Accumulation and ineffective removal of these by-products of dissolution in the IEG negatively impact many areas of the ECM process including speed, cost, surface finish, and/or dimensional tolerances, for example. Gas generation in the IEG, often misinterpreted as sparking or interference by by-products of dissolution, results in poor surface finish and reduces dimensional precision. Secondarily, the non-gaseous, ionic by-products of dissolution create an electrical insulating layer immediately adjacent to the work piece (referred to herein in its fully characterized form, as identified and defined by the inventor herein, as the Beta Insulating Layer or “BIL”) which inhibits all aspects of the ECM process. While the ECM process has been in practice for many years, the prior art has failed to overcome many of the negative effects caused by gas generation and has failed to recognize the criticality of fully understanding the BIL which is believed to be due, at least in part, by a failure to recognize the exact composition and fluid dynamics of the BIL as well as the interactions between the work piece, IEG, tool and BIL during the ECM process. Although it is impossible to completely eliminate the formation of gases in the IEG and the electrically insulating effect of the BIL, there remains a need for an improved ECM process and apparatus which more effectively controls the formation of gases and the directed removal of the BIL in the IEG during the ECM process.

### SUMMARY OF THE INVENTION

The present invention controls gas formation in the IEG and fully characterizes and defines the BIL composition and related fluid dynamics during the inventive ECM process and, in so doing, successfully addresses the problems plagued by the prior art ECM processes described above.

In ECM, improvement in the machining rate of the work piece is desirable, however, the prior art has generally associated higher currents with higher machining rates, but have failed to understand or recognize that high currents also generate an undesirable high rate of hydrolysis of the electrolyte. High rates of hydrolysis leads to the formation of an excessive amount of gas bubbles comprising O and O₂ molecules emanating from the anodic work piece and H and H₂ emanating from the cathodic tool. These gas bubbles interrupt the electrical contact between the anode and the cathode having an electrical insulating effect. Also, if the BIL is not being continuously removed from the work piece during machining, the BIL accumulates in the IEG and gas bubbles ultimately push through the accumulated BIL which creates momentary voids in the BIL which, in turn, allow a momentary and uncontrolled clear current path to the work piece. Since the voids may appear anywhere in the BIL immediately adjacent to the work piece surface, this phenomenon creates pitting in the work piece surface as well as poorly defined edges at the peripheral boundaries of the point of machining. This phenomenon of surface pitting and poor surface edges occurring due to gas bubbles pushing through an accumulated BIL has not been previously recognized by the prior art and hence has not heretofore been adequately addressed.

The present invention addresses the above problem in one manner by minimizing electrolyte hydrolysis and the resultant formation of gas bubbles through proper selection and control of the applied voltage. The present invention addresses the above problem in another manner by constantly and uniformly removing the BIL by direct perturbing of the BIL (also referred to herein as “perturbation” or “mechanical perturbation”) with the tool in an optimally maintained very small IEG which may be in the range of about 0 (infinitely close, but not touching) to about 10 microns. As will be described more fully below, the inventor herein has measured the BIL as forming adjacent to the work piece within this range of about 0 to about 10 microns. The BIL encapsulates the layers, cumulatively measuring 0 to 1 microns, described by the Helmholtz (otherwise referred to as the double layer or electrical double layer) and Gouy-Chapman-Stern (including the screening and adjacent diffuse layers) models, as well as the conventions described as the slipping plane that separates mobile fluid from fluids attached to the surface of the anode and/or cathode. The layer models, inclusively, describe the distribution of ions and charges near the electrode surface whereby a diffuse layer of charge is formed in the electrolyte with the net charge highest near the electrode surface and the concentration of ions diminishing away from the interfacial region immediately adjacent to the surface of the electrode until the distribution of ions becomes homogenous.

More particularly, in one embodiment of the invention, the inventive ECM method includes the step of determining the optimum ECM operating voltage and current at which to machine the work piece. The optimum maximum voltage for a particular type of work piece material may be identified using a potentiostat voltammetry sweep triggered between the work piece material to be machined and a cathode comprising the cathode material used in the inventive ECM system under a set of conditions reflective of those used in the ECM system including the selected electrolyte. The optimum maximum voltage is identified by actively monitoring the current while voltage is gradually increased from zero or near zero volts. As voltage in increased, the current is monitored and the point at which the current begins to increase rapidly defines the Low Machining Potential Voltage (LMPV) at which the actual onset of material dissolution occurs for this particular work piece. The voltage is then continually increased until a decrease in the rate of current increase is detected which defines the High Machining Potential Voltage (HMPV) that should be used during the inventive ECM process on the work piece without initiating excessive hydrolysis of the electrolyte. Thus, both the LMPV (approximate lowest acceptable voltage) and HMPV (approximate highest acceptable voltage) used to machine the work piece is determined. Although it is preferred to use the HMPV to achieve the highest machining rate, any voltage between the LMPV and the HMPV is suitable. Should an even higher voltage be used, the resultant increase in current would be devoted to hydrolysis of the electrolyte, thus further degrading dimensional tolerances.

The prior art, believing the higher the current, the higher the machining rate, have used voltage and currents higher than the optimal voltage and current as identified herein. When the prior art see problems with the resultant machining surface, they attribute it to sparking or interference by the by-products of dissolution. In response to this problem, the prior art, due to a failure to recognize that the higher current is directed at generating more gas rather than machining, reacts by attempting to keep the high voltage and current while putting more effort into removing the by-products of dissolution which they do by a variety of means (e.g., pulsing the electrolyte through the IEG with pressure waves or oscillating the tool relative to the work piece to allow for an oscillating increase in the spacing of the IEG, with or without an in-phase pulsing of the current during maximum IEG spacing). In this instance, the prior art is, in actuality, intermittingly turning off the machining current while simultaneously increasing the IEG spacing in an attempt to forcefully clear away the built up by-products. In the example of prior art U.S. Pat. No. 6,835,299, the oscillating tool has a back and forth movement with respect to the work piece which thus alternately increases and decreases the IEG spacing with a simultaneous pulse off mode of the current during the temporary increase in IEG. According to this patent, this increase in IEG spacing with the machining current off is an attempt to clear away the accumulated by-products which of course is also temporarily turning off the machining process which negatively impacts machining speed and consistency of dimensional accuracy.

In another aspect of the invention, the composition of the insulating layer has been fully characterized and termed the Beta insulating Layer (BIL) herein thereby allowing precise control over the formation and accumulation thereof in the IEG. In an embodiment of the invention, the inventive ECM method constantly and uniformly removes the BIL by constant and direct perturbing of the BIL with the tool in an optimally maintained very small IEG which may be in the range of about 0 to about 10 microns. The result is a fast machining rate with a very smooth machining surface (±0.2 μin) not heretofore attainable using prior art ECM methods. The tool may be configured to constantly and simultaneously pull and push the electrolyte into and out of the IEG which, with constant perturbation of the BIL, results in the constant removal of the BIL in the present invention which prevents the adverse machining effects caused by the uncontrolled build-up of dissolution by-products which the prior art allows to at least temporarily accumulate in between their generally ineffective attempts to sweep away the accumulated by-products.

### BRIEF DESCRIPTION OF THE DRAWINGS

A more particular description of the invention briefly summarized above is available from the exemplary embodiments illustrated in the drawings and discussed in further detail below. Through this reference, it can be seen how the above cited features, as well as others that will become apparent, are obtained and can be understood in detail. The drawings nevertheless illustrate only typical, preferred embodiments of the invention and are not to be considered limiting of its scope as the invention may admit to other equally effective embodiments.

FIG. 1 is a schematic of the inventive ECM system according to an embodiment of the invention;

FIGS. 2a-2f are simplified side elevational views of an exemplary work piece through stages of preparation for the ECM process;

FIG. 3 is a graph of a typical potentiostat voltammetry curve, only one half of a single sweep displayed;

FIG. 4 is a time vs. current graph showing the rapid formation of the BIL with a first curve (L1) illustrating devolution into the staid isotropic dissolution state, and a second curve (L2) showing the effects of perturbation of the BIL in accordance with the present invention;

FIG. 5a is a simplified side elevational view of one embodiment of a tool wheel in proximity to the machining end of the work piece;

FIG. 5b is a cross-section as taken generally along the line 5b-5b in FIG. 5a;

FIG. 6 is a diagrammatic representation of the basic anisotropic machining chemistry of an embodiment of the invention;

FIG. 7 is a photomicrograph of a surface successfully machined in accordance with the present invention;

FIG. 8 is a current vs. time graph of the working example provided herein;

FIG. 9 is a diagrammatic representation of a potentiostat setup for determining the LMPV and HMPV;

FIG. 10 is a diagrammatic representation of the unperturbed gradient of the BIL;

FIG. 11 is a photomicrograph of a surface measurement obtained on a successfully machined work piece surface using a Scanning Electron Microscope;

FIG. 12a is a graph showing Preferred Operating Voltage (POV) varying with surface area;

FIG. 12b is a simplified graphic demonstrating that at a single unadjusted operating voltage there is an overall increased generation of gas in the IEG as the surface area of the work piece expands;

FIG. 13 is a graph showing Preferred Perturbation Speed (PPS) of the perturbing cathode tool and/or anode work piece varying with surface area; and

FIG. 14 is a schematic of an alternate embodiment of the work piece holder.

### DETAILED DESCRIPTION OF PREFERRED EMBODIMENTS

So that the manner in which the above recited features, advantages, and objects of the present invention are attained can be understood in detail, more particular description of the invention, briefly summarized above, may be had by reference to the embodiment thereof that is illustrated in the appended drawings. In all the drawings, identical numbers represent the same elements.

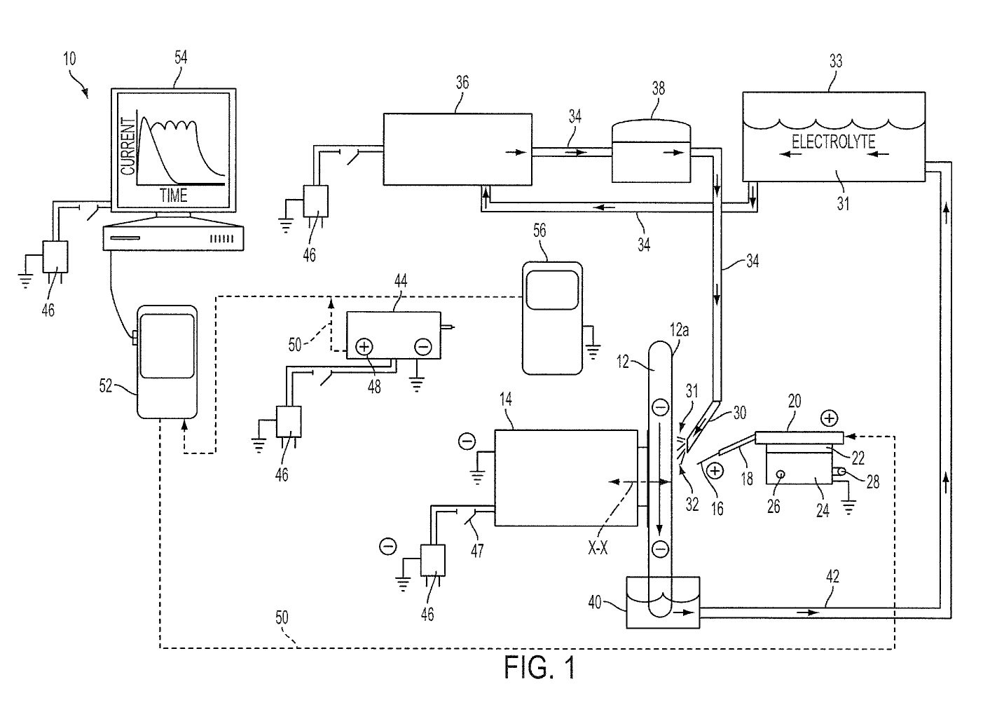

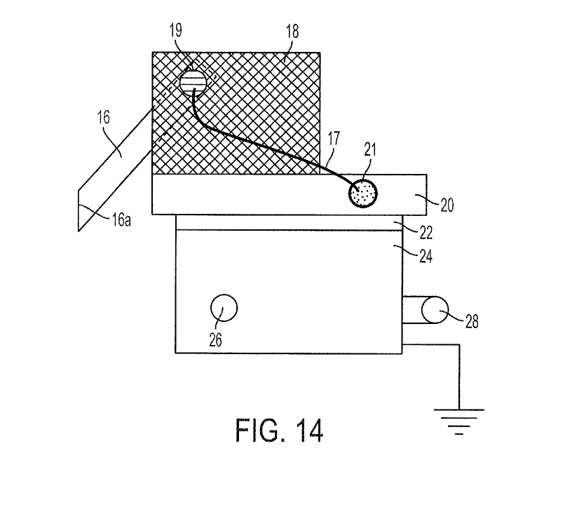

FIG. 1 illustrates the inventive ECM system according to one possible embodiment of the invention indicated generally by reference numeral 10. In this embodiment, a tool 12 is provided in the form of a cast iron wheel which may rotate via variable speed motor 14 about its spindle axis x-x although it is understood that other tool configurations are possible. An electrically conductive work piece 16 to be machined is mounted in a holder 18 which is formed from an electrically conductive material such as brass, for example. In another embodiment described below with reference to FIG. 14, the holder 18 can be made of an electrically insulating material such as acrylic with an internal electrical conductor such as a copper wire which delivers a positive electric charge to work piece 16 using an intermediary material such as an electrically conducting polymer to connect the work piece 16 to work piece holder 18. Work piece holder 18 is itself mounted to a conductive holder 20 (e.g., stainless steel) which is mounted on an electrically insulating plate 22 which in turn is mounted on XY motion controller 24 having X and Y control knobs 26 and 28, respectively. Although manual control knobs are illustrated, it is understood that the XY movement (and along a Z axis, if desired) may be computer controlled if desired. In another embodiment (FIG. 14), the holder 18 can be made of an electrically insulating material such as acrylic with an internal electrical conductor 17 such as a copper wire which delivers a positive electric charge to work piece 16 using an intermediary material 19 such as an electrically conducting polymer to connect the work piece 16 to holder 20 via a mechanical/electrical connection 21 such as a screw.

Based on the selected work piece material, an electrolyte 31 is selected for the purposes of conducting current established by a set voltage between the anode and cathode. In the present invention, this electrolyte may take the form of inorganic or organic electrolytes or molten salts, for example. An electrolyte outlet tube 30 is provided for delivering the selected electrolyte 31 to the inter-electrode gap (IEG) 32. Electrolyte 31 is delivered to outlet tube 30 from a reservoir tank 33 which delivers electrolyte via tube 34 to a pump 36 and flow dampener 38 to allow metering of the amount of electrolyte reaching outlet tube 30. Electrolyte is recovered in sump 40 with recaptured electrolyte directed back to reservoir 33 via tube 42.

A power supply 44 is provided which may be in the form of a VAC-VDC converter with a 0-50 VDC variable output receiving power from a 110 VAC plug 46. The DC positive terminal 48 leads via circuit line 50 to holder 20 which delivers a positive electric charge to work piece 16 which thus comprises the positive anode in the ECM system while tool 12 comprises the negative cathode via its connection to ground on motor 14. A digital DC current meter with IR data logger output 52 (available from Agilent Technologies) is connected to circuit line 50 to allow real-time monitoring of current delivered to work piece 16 via output screen 54 displaying a time/current graph of the ECM system in operation capable of displaying current charges in the 0.1 mA level with a maximum of 100 mA and a minimum of zero mA. Voltage output is likewise monitored on a digital volt meter 56 connected to power supply 44.

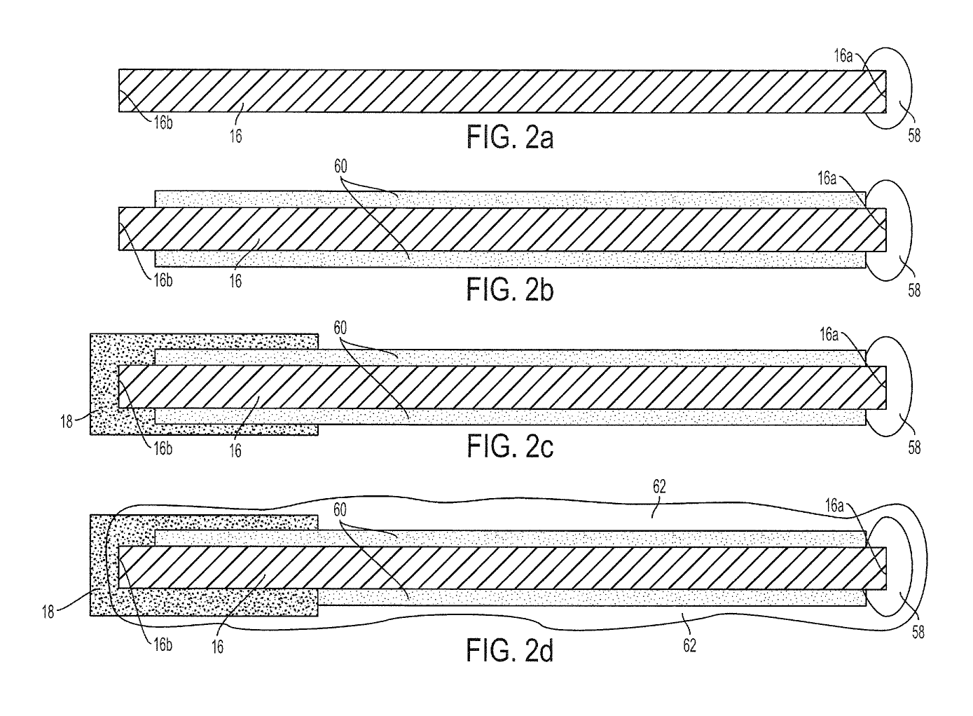

FIGS. 2a-2d illustrate the preparation of an exemplary work piece 16 for machining in an ECM system. In this embodiment, the work piece is made of an electrically conductive material such as the aluminum-doped Silicon Carbide (SiC) which is the subject of commonly owned U.S. Pat. No. 6,616,890, the entire disclosure of which is incorporated herein by reference. It is understood, of course, that the invention may be used to machine any electrically conductive material including but not necessarily limited to all metals, alloys, and composites thereof. In this example, the work piece 16 is first shaped into a blank having a rectangular shape with a high aspect ratio intended to be machined into a surgical blade. SiC is known to be extremely corrosion resistant and durable and is therefore desirable as a material for manufacturing parts that would benefit from these properties such as the aforementioned surgical blades. It is also known, however, to be very difficult to machine with speed and accuracy and is not frequently used as the material of choice for this reason.

The '890 patent describes a method by which the SiC may be doped with aluminum or alumina to make it homogenously electrically conductive allowing it to be machined using the inventive ECM process. While the aluminum-doped SiC is indeed electrically conductive, the inventor herein has found that electrical resistance of a work piece increases with increases in aspect ratio and therefore the electrochemical machining results may be even further optimized by applying what is termed herein a “fugitive electrode” prior to machining. Although the example of work piece 16 herein includes such a fugitive electrode 60 as will be described, it is understood that other chosen work pieces may have sufficient conductivity due to their material composition and/or shape and not require a fugitive electrode.

In FIG. 2a, the end 16a of work piece 16, intended to be machined into a blade in this example, has a first removable coating 58 applied thereto. First coating 58 may be formed of any suitable material which will protect the end 16a during the application of the fugitive electrode 60 seen in FIGS. 2b-2d. Suitable materials for first coating 58 would include but are not necessarily limited to polymers such as silicone, urethane, or cyanoacrylate, for example. Once first coating 58 has been applied to end 16a, fugitive electrode 60 is applied to the uncoated portions of work piece 16 as seen in FIG. 2b. The fugitive electrode may be applied using any electrically conductive coating material such as Nickel in a Nickel plating process, for example. In FIG. 2c, the work piece end 16b opposite the machining end 16a is mounted into a suitable electrically conductive holder 18 which may be formed of brass, for example. A second removable coating 62 such as wax or silicone, for example, is then applied to the work piece to cover and protect at least those areas that are not intended to be machined by the inventive ECM process.

In FIG. 2d, the work piece 16 is seen to be completely covered by first coating 58, fugitive electrode 60, holder 18 and second coating 62. FIG. 2e illustrates the step of abrading away the coatings 58 and 60 to reveal work piece end 16a using spinning wheel 12 (and, if necessary, a suitable lubricant 59) although it is understood that any suitable manner of removing the coatings at end 16a may be used. Lastly, FIG. 2f illustrates the work piece 16 ready for machining following removal of coatings 58 and 60 to reveal work piece end 16a which will be machined using the inventive ECM process as described herein. Work piece 16 is then transferred to the inventive ECM system 10 by inserting brass holder 18 into stainless steel holder 20. Brass holder 18 positions the work piece 16 into proximity of the planar side surface 12a of tool 12 at an angle reflective of the desired angle to be machined onto the work piece end to form the intended sharp edge of the surgical blade (see FIG. 1). Once the power supply 44 is activated, a positive application of voltage enables DC current to travel along line 50 to holder 20 which conducts through brass holder 18 to reach work piece end 16b and fugitive electrode 60. As seen in FIG. 2f, fugitive electrode 60 extends the length of work piece 16 to a point adjacent end 16a which is the end to be machined into a blade in this example. A small amount of first coating 58 remains about end 16a to protect the areas of work piece 16 not intended to be machined, as well as to protect the distal end 60a of fugitive electrode 60. With the assistance of fugitive electrode 60, positive voltage is applied causing a current to flow in the circuit through work piece 16 to work piece end 16a which thus forms the anode in the inventive ECM system.

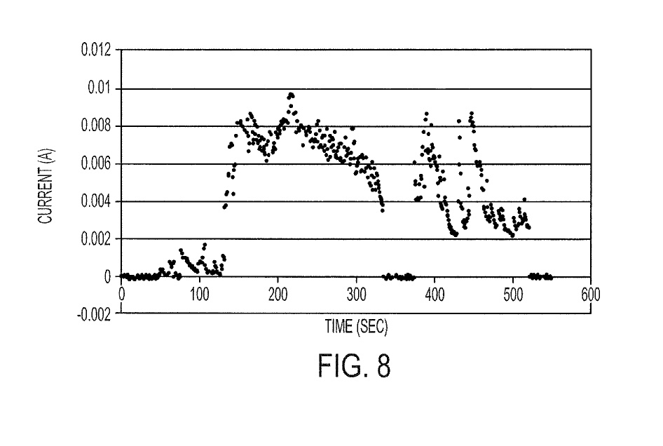

As described above, the inventive ECM method includes the step of calculating the optimum inventive ECM operating voltage and current at which to machine the work piece which will vary depending on the material type and characteristics. This may be done by experimentation as illustrated in FIG. 9 where the reference electrode is preferably a Saturated Calomel Electrode.

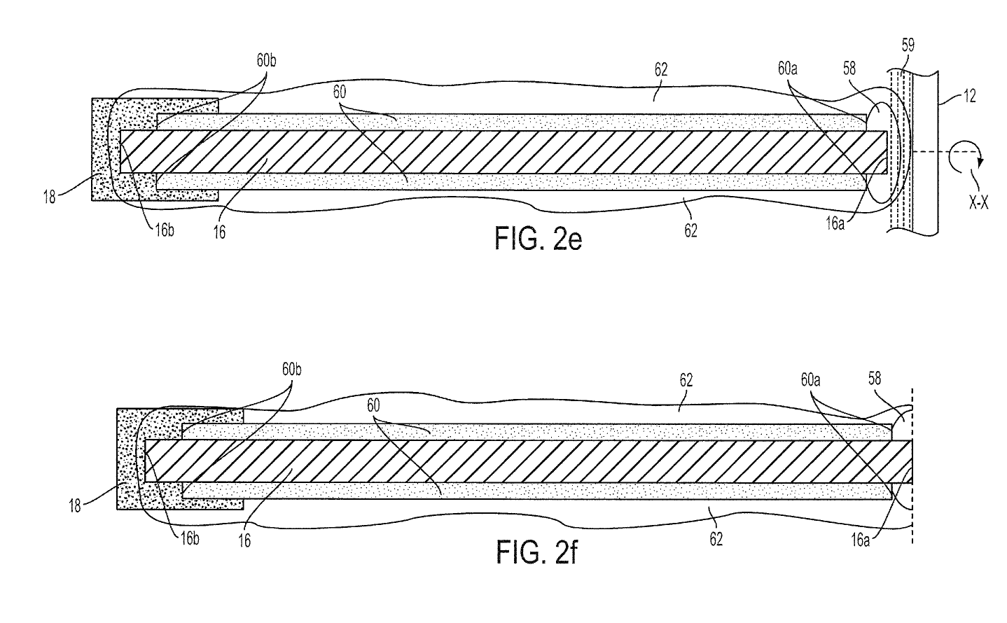

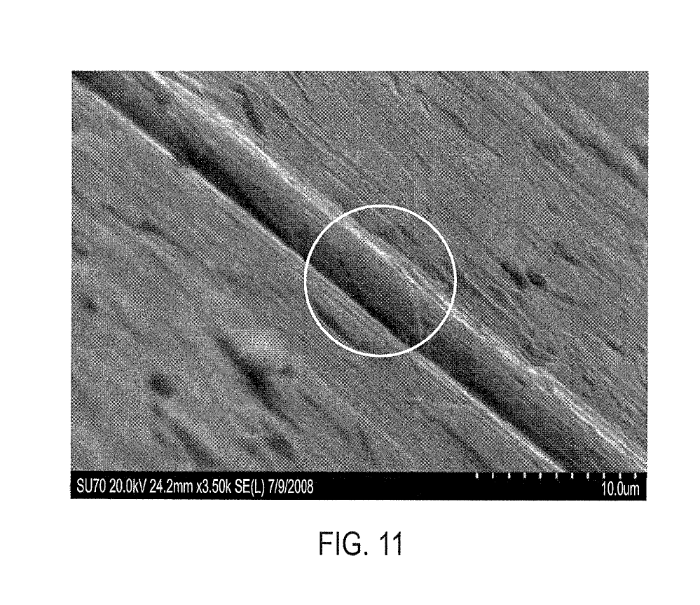

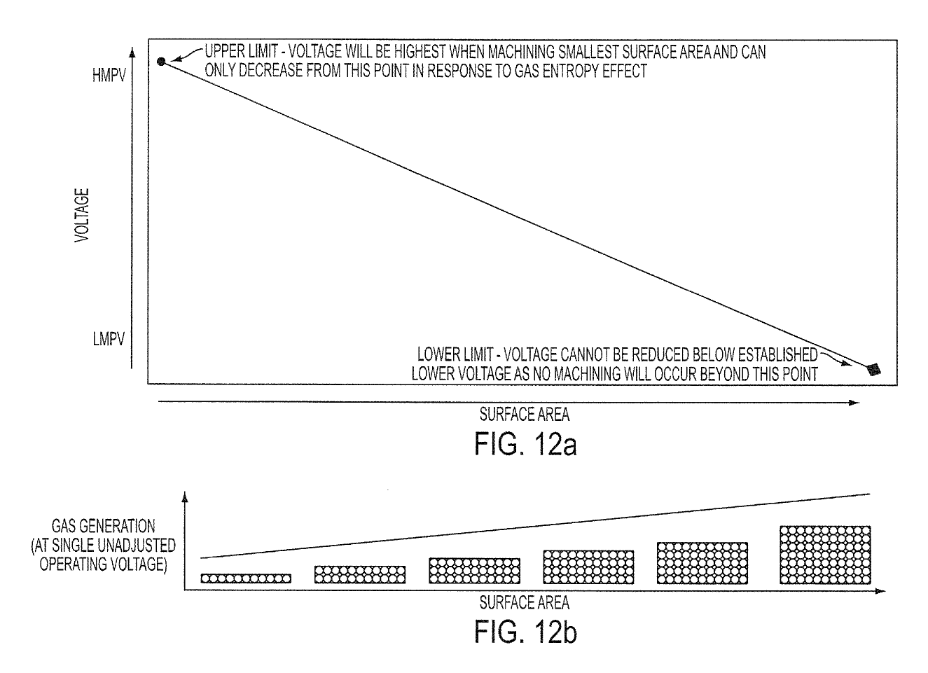

The LMPV (Low Machining Potential Voltage) and HMPV (High Machining Potential Voltage) for a particular type of work piece material may be identified using the work piece in the potentiostat system of FIG. 9 by actively monitoring the current while voltage is gradually increased from zero or near zero volts. FIG. 3 illustrates a typical Potentiostat Voltammetry Curve (only one half of a single sweep displayed) using the apparatus setup of FIG. 9 wherein point “A” represents the approximate DC voltage of 2 VDC where the material begins to appreciably dissolve (LMPV). Point “A” is identified at the point of the curve where current starts to rapidly increase as voltage is being slowly increased. Point “C,” which reads at about 2.8 VDC, is designated the HMPV point where the work piece dissolution is at an optimally high rate with minimum hydrolysis and associated gas production. Point “C” is identified when the curve begins to level off (i.e., a decrease in rate of change). The Preferred Operating Voltage (POV) (FIG. 12a) is a point at either one of or somewhere between the HMPV and the LMPV wherein the dissolution of the work piece material is at an efficient maximum with regard to the electrolyte and the aspect ratio of the machined area. As noted above, work piece 16 in the embodiment described herein is a high aspect ratio part. Low aspect ratio machined surfaces (meaning higher surface area at the machining site) are more vulnerable to blockage by process generated gasses than are high aspect ratio machined surfaces as will be described further hereinbelow (FIG. 12b). Consequently, the POV decreases with increasing surface area to compensate for increased total gas generated in the IEG as surface area expands. Decreases to the POV are not directly correlated to surface area and require close monitoring of current and output parameters. Adjustments to the POV are required to control gas generation and prevent Gas Entropy from disrupting the machining process. If the POV is not adjusted accordingly, the total amount of gas generated in the IEG, which increases with the expanding surface area, will result in the Gas Entropy Effect (FIG. 12b).

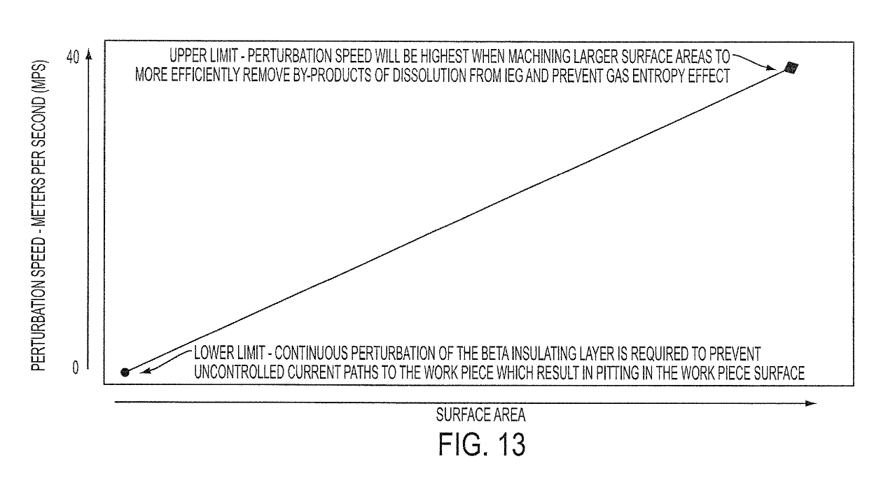

As illustrated in FIG. 13, the selected speed at which the variable speed motor 14 rotates the wheel 12 in this embodiment is also dependent upon the surface area of the work piece. The Preferred Perturbation Speed (PPS), or the ideal speed at which the tool 12 directly perturbs the BIL, must be increased to compensate for a larger surface area in order to efficiently and effectively remove all by-products of dissolution, both gaseous and non-gaseous, while simultaneously introducing fresh electrolyte into the narrow IEG. As illustrated in FIG. 12b, the total amount of gas generated in IEG increases with expanding surface area. If the PPS is not increased when machining a growing and/or larger surface area, the IEG will become choked by an uncontrolled and growing BIL and excessive hydrolysis. This excessive hydrolysis generates excessive gas in the IEG resulting in the Gas Entropy Effect (further described below). Adjustments to PPS are required to control gas generation and prevent Gas Entropy from disrupting the machining process whereby uncontrolled voids form in the BIL which pit the work piece surface. Additionally, when machining a smaller surface area, if the PPS is too high, the process runs the risk of creating cavitation in the electrolyte which will pull the BIL away from the targeted machining site on the surface of the work piece creating a vacuum where the BIL previously existed. Machining current flow will therefore cease in this area. Increases to the PPS are not directly correlated to surface area and require close monitoring of current and output parameters.

Referring again to FIG. 3, the range between points “A” and “C” indicated by line “B” represents the permissible range of voltages for the particular work piece used to obtain the voltammetry curve. In this context it should be understood that the higher the voltage above point A, the higher the work piece dissolution and the higher the generation of the previously described mechanically inhibiting gases for a given machined surface and aspect ratio. This individual voltammetry curve is a function of the specific work piece material, the electrolyte selection and concentration of that electrolyte material, and the range of the voltage applied to the system. This curve is thus broadly applicable to the establishment of the LMPV and HMPV machining inflection points for all electrolytes, electrically conductive work pieces and voltage ranges.

Thus, as voltage is increased, the current is monitored and the point “A” at which the current begins to rapidly increase defines the voltage at which the actual onset of material dissolution occurs (LMPV) for this particular work piece and the corresponding predetermined set of machining conditions. The voltage is then continually increased until a decrease in the rate of current increase is detected at point “C” which defines the maximum voltage (HMPV) that should be used during the inventive ECM process on the work piece without initiating excessive hydrolysis of the electrolyte. Thus, by using this method, both the approximate lowest acceptable voltage (LMPV) and approximate highest acceptable voltage (HMPV) used to machine the work piece is determined. Although it is preferred to use the approximate highest acceptable voltage (HMPV) to achieve the highest machining rate, any voltage between the onset of dissolution voltage and the HMPV is suitable. For higher surface area machining sites, gas generation may be limited by operating the inventive ECM system at a POV near the lower end of the range indicated by line “B” (See also FIG. 12a). Should a voltage higher than the HMPV be used, the resultant increase in current would be devoted to hydrolysis of the electrolyte, not efficiently machining the work piece, which only acts to inhibit machining speed, not to efficiently increase it and is therefore undesirable due to the creation of gas pit damage.

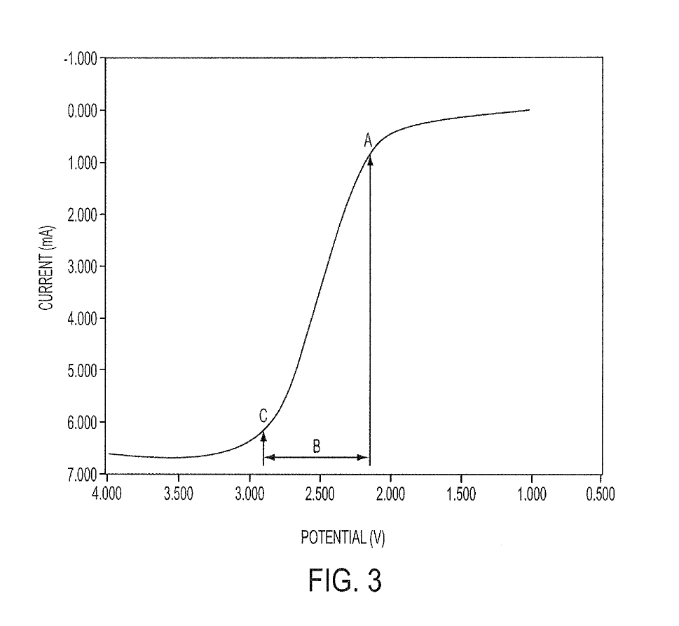

Once the HMPV has been determined, the inventive ECM process may be initiated using the HMVP as the starting voltage connected to the anode work piece 16 and the negative electrode connected to the cathode tool 12. The work piece 16 is moved into proximity of the planar side surface 12a of tool 12 at a first distance of at least approximately 50 microns. All power is turned on in system 10 and electrolyte is directed out of tube 30. The operator then advances the work piece 16 toward the tool surface 12a into the BIL region of about 0 to about 10 microns from the tool surface 12a defining the IEG 32. As seen in FIG. 4, a simplified graph output of screen 54, the first curve that will be observed is curve “L1” which has an initial peak at point “E” (within the first approximately 100 milliseconds of power turn-on) and represents the initial forming of the above-described BIL. The current peak then rapidly decreases and levels off to a stasis current “D” level of approximately 3 mA. This is due to the forming of the BIL which electrically insulates the work piece from the machining process as explained above.

To begin the machining of the work piece, the work piece 16 is moved to within 10 microns or less of the tool 12 setting the IEG at between about 0 and about 10 microns. An IEG range maintained between about 0 and 10 microns enables the controlled, direct perturbation of an explicitly targeted area of the BIL immediately adjacent to the work piece in a uniform and constant manner (defined by the inventor and referred to herein as “anisotropic machining” of the work piece as will be discussed further below). Machining without the use of a direct perturbing tool and/or an IEG greater than about 10 microns results in an “isotropic machining” of the work piece which is undesirable and the subject of much of the ECM prior art.

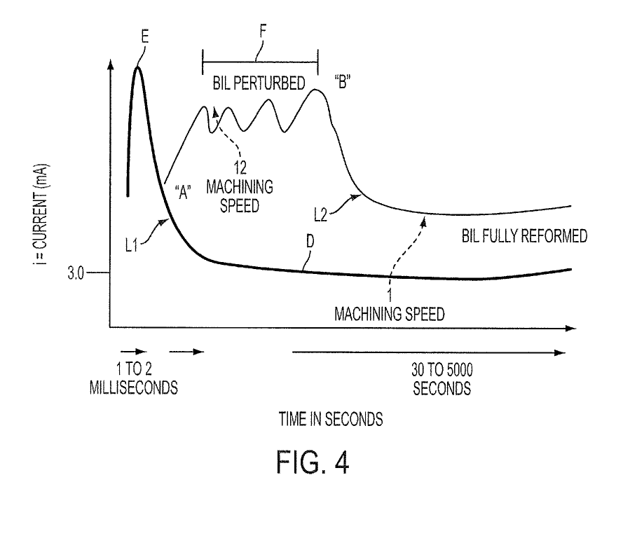

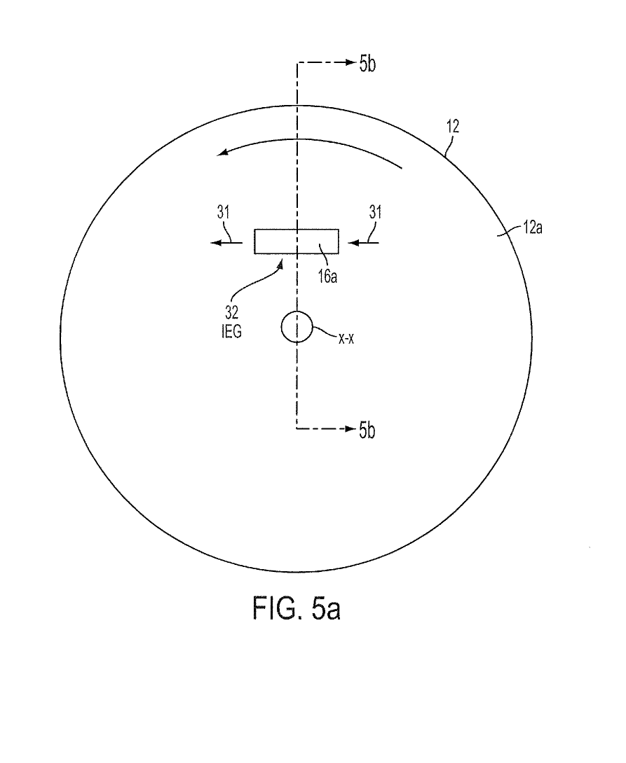

As seen in FIGS. 5a and 5b, the machining end 16a is facing the rotating planar side surface 12a of tool 12. As such, the tool surface 12a is constantly and uniformly passing by the work piece end 16a which acts to constantly and simultaneously pull and push electrolyte 31 into and out of the IEG 32. In addition to constantly and simultaneously pulling and pushing electrolyte into and out of IEG 32, the moving tool surface 12a also acts to constantly and uniformly perturb the BIL which is thereby dislodged and swept out of the IEG 32 along with the electrolyte 31. As will be described in further detail below, the BIL is constantly and uniformly forming and reforming during the inventive ECM process, and the moving tool's 12 direct mechanical perturbation of the BIL continuously removes the BIL almost as fast as it forms and re-forms thereby preventing any accumulation of the BIL immediately adjacent to the work piece in the IEG which is a problem plagued by the prior art. Thus, this constant, direct mechanical perturbation of the BIL together with the constant forced flushing of the electrolyte through the narrow IEG provides the optimized machining results the present invention affords as described herein, particularly when coupled with a Preferred Perturbation Speed (PPS) (FIG. 13) which acts to sweep away the BIL, remove gases and supply fresh electrolyte to the IEG, and a Preferred Operational Voltage (POV) (FIG. 12a) initially set at the HMPV which acts to inhibit excessive gas generation due to hydrolysis as explained above.

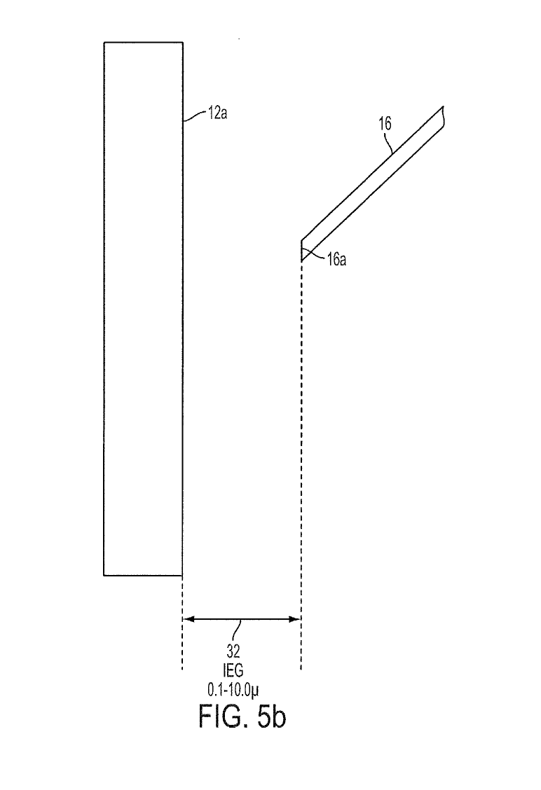

FIG. 6 illustrates the in-process electrochemical machining of the SiC work piece made more rapid by the mechanical removal of the BIL through direct mechanical perturbation (depicted as a force vector). The surface coating of Si0₂ is shown partially removed and the gas chemistry is shown removing the carbon in the form of CO and CO₂ in this simplified review. Each Si atom is removed as a neutral SiOH phase and becomes part of the BIL forming immediately adjacent to the work piece surface. This same process description is applicable to all electrically conductive metals, semiconductors and resistors. In the case of metals, the individual metal atoms take the place of the Si in FIG. 6. Metallic inclusions in processed metals such as Carbon, Nitrides, Metal oxides etc. are removed in the same or similar manner as described above.

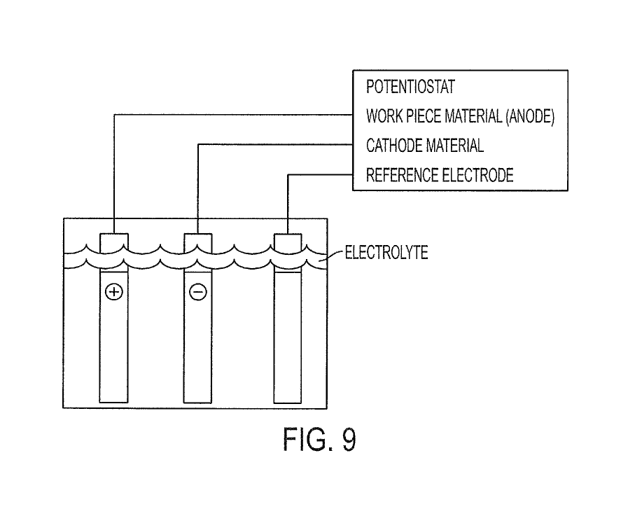

In this embodiment of the invention, the hierarchy of material removal is as follows:
1. Voltage is applied to the anode and cathode in an electrolyte solution causing an increase in the decomposition of H₂0 into H and OH— with the H molecule departing the IEG as a gas at the cathode surface (FIG. 6. Step #1).
2. The OH— ion created in Step 1 migrates as an anion to the SiC anode (FIG. 6. Step #2) where it scavenges a Si atom from the Si0₂ native layer formed on the surface of the SiC work piece (FIG. 6. Step #3) forming a SiOH molecule (FIG. 6. Step #4-A) and making available an O₂ molecule. The SiOH molecule in solution in the electrolyte forms the BIL immediately adjacent to the work piece in the electrolyte comprising the IEG. Unperturbed, this BIL will continue to develop immediately adjacent to the work piece as a gradient of molecules comprised of a declining density distribution of neutral molecules further away from the anode surface (FIG. 10). Prior art relies on the flushing action of the electrolyte to remove those molecules comprising the BIL from the IEG. However, the most dense distribution of molecules comprising the BIL, those that are immediately adjacent to the anode surface, requires the direct perturbation of the BIL indicated in the inventive ECM system to more effectively expose the underlying SiC, further detailed herein, to more rapidly remove Si material from the work piece.
3. The O₂ from Step 2 either (a) gases off, departing the surface of the anode as an O₂ molecule, (b) bonds to a free Si molecule rejoining the Si0₂ layer, or (c) scavenges a CO molecule as in Step 5.
4. The Si molecule removed from the Si0₂ layer in Step 2 creates a Si vacancy in the Si0₂ layer which must be replenished by Si. In the case of sufficient depth penetration through the entire Si0₂ layer into the anode material, the Si vacancy is filled by a Si atom from the SiC matrix. Removal of Si from the SiC matrix leaves an exposed C atom.
5. The C atom from Step 4 departs the surface of the anode by combining with available oxygen as CO or CO₂.

The above describes the basic chemistry as presently understood, it being noted that there may be other more complex molecular reactions and temporary partial reactions within the chemical dissolution framework taking place as the machining progresses down through the SiC matrix. Without the direct perturbation of the BIL in Step 2, the dissolution reaction quickly proceeds to a Diffusion Limited Reaction (DLR), limited by the electrical resistance encountered due to the unperturbed build up of SiOH in the BIL.

When voltage is applied to the inventive ECM system under a predetermined set of conditions (including selection of the anode, cathode, and electrolyte concentration such as in Example 1 below), the current initially surges beginning with the charging of the Helmholtz layer curve “L 1” which peaks at point “E” (within the first 100 milliseconds of power turn-on) and represents the initial forming of the above-described BIL. Anisotropic machining is best achieved during this initial peak in current, with this current being maintained through the direct perturbation of the BIL. Without direct perturbation of the BIL, the current rapidly settles down to a long term isotropic dissolution (the isotropic machining curve illustrated as section “D” in FIG. 4) at an extremely slow dissolution rate. Without direct mechanical perturbation of the BIL, a fully developed electrically resistive BIL will form to effectively reduce the voltage available to dissolve the work piece at the electrolyte interface.

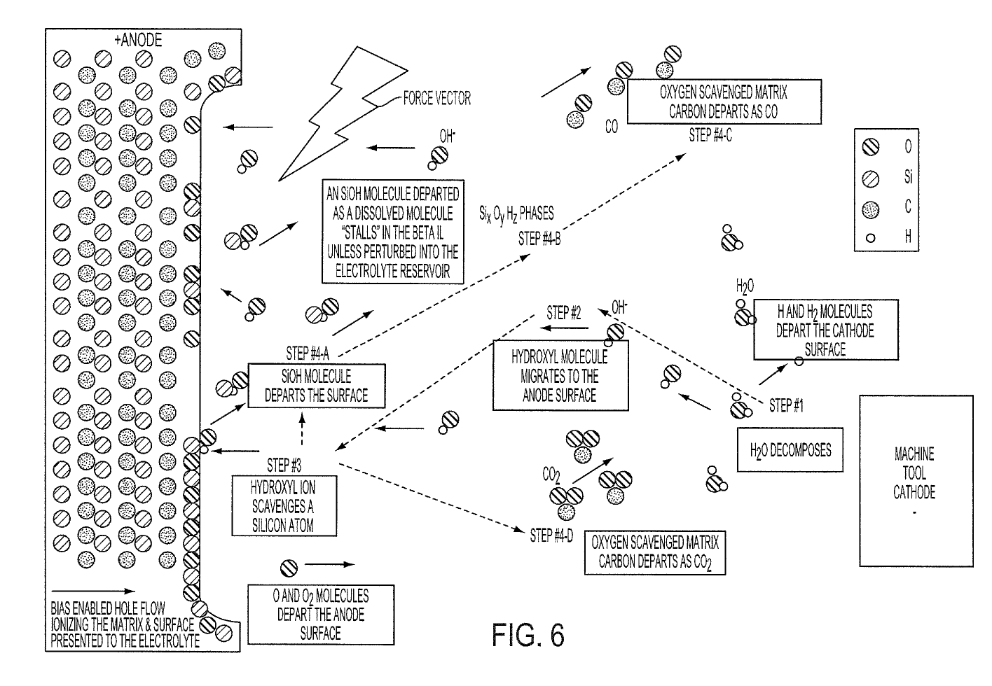

When the BIL is directly perturbed as seen in curve section “F” in FIG. 4, the current rapidly rises to a value close to the initial peak at point “E”. The current flow is maintained at this high rate by a continuous and uniform direct perturbation along the entire intended machining area of the work piece. This anisotropic material removal is self leveling and rapid when focused in the BIL region of about 0 to about 10 microns immediately adjacent the work piece surface in the IEG. Successfully machined with a well controlled electrical shutdown process, the work piece surface is colorful, there is little pitting, grain boundaries are tight with limited grain pullout and the Si0₂ surface is transparent as seen in FIG. 7.

### Example 1

A ceramic blade blank approximately (3 mm×7 mm×300 microns) was machined as described below using a work piece made of doped silicon carbide as described in commonly owned U.S. Pat. No. 6,616,890.

A first removable, electrically insulating coating comprising silicone material 58 was applied to the end 16a of the above-described blade blank 16 where machining was intended to occur. The blank 16 was then dipped into a Nickel plating bath to metalize the uncoated areas of the work piece to a plating thickness of 25-50μ. The plating was a continuous, lustrous coating of Ni 60. The plated work piece was then mounted in a brass holder 18 using an electrically conductive epoxy and then coated with a second removable, electrically insulating coating comprising wax 62 which covered the plating 60 as well as the first coating 58.

### Preparing the Machine Set-Up

The brass holder 18 was then mounted into an electrically conductive steel holder of an X-Y mechanical, micrometer position controller 24 which itself was mounted to a tool platform 24 positioned adjacent the tool which comprised a rotatable wheel 12. The end 16a of the work piece to be machined was then moved into spaced relation to the planar side surface of the wheel 12a and an electrolyte feeding tube 30 was then positioned above and slightly behind the work piece with the tube outlet directed at the IEG 32 between the tool and work piece. The electrolyte feeding tube 30 was connected to an electrolyte reservoir 33 having a pump 36 and a dampener 38 operable to deliver the electrolyte through the feeding tube 30 to the IEG 32 space between the tool and work piece. Using the mechanical micrometer controls on the X-Y controller 24, the work piece was moved into a position where the IEG 32 between the work piece 16 and tool 12 was observed to be greater than 10 microns. The work piece was moved toward the spinning tool 12. The first 58 and second 62 coatings were then removed from the end 16a of the work piece where machining was to occur. This was done by passing the work piece end 16a over the spinning wheel 12 (unconnected to the negative terminal of the power source at this point) until the coatings were abrasively removed as depicted in 2f. A digital volt meter 56 and digital ampere (current) meter 52 (with data logging capability) was connected in the manner shown in the electrical schematic labeled FIG. 1. Note the data logging capability is directly out of the DCA current meter 52. While a variable power supply is depicted in FIG. 1, in this Example 1, a 12V lead-acid multi-cell battery was used as the power source. The positive terminal (+) of the battery was connected to the work piece holder 20, and the negative terminal (−) was connected to the tool 12. The polarity and interconnections with the data recording meters were then confirmed as shown in the electrical schematic FIG. 1.

### Initiating the ECM Process

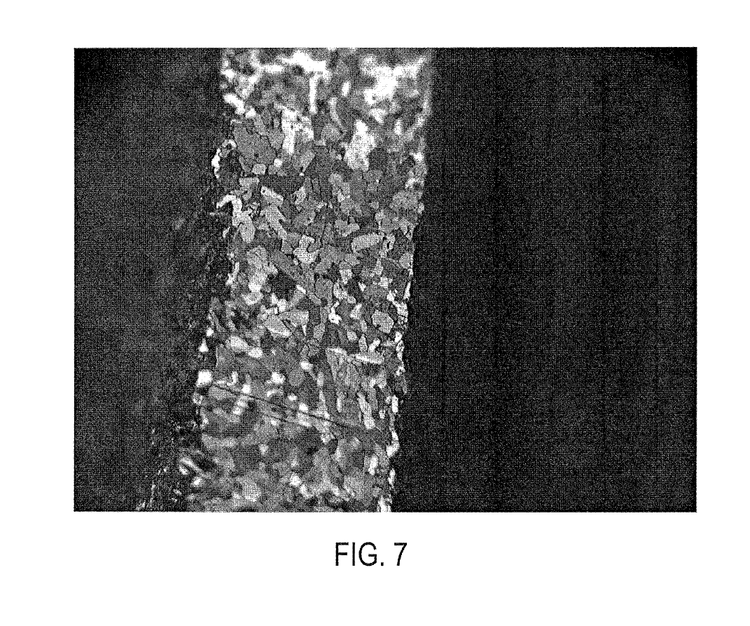

The electrolyte reservoir tank 33 was filled with a two molar concentration of NaCI, for example, in deionized micro filtered water and the electrolyte pump 36 was then turned on. The electrical power to the wheel tool was then turned on via switch 47 which started the wheel tool 12 spinning. A small wave of electrolyte flowing over the end of the work piece 31 was observed which confirmed the work piece 16 was in contact with the electrolyte flowing between the work piece 16 and spinning wheel 12 tool. The work piece end 16a was then moved greater than 10 microns away from the surface of the spinning wheel (cathode) 12. The power source 44 to the anode 16 and cathode 12 was turned on at the HMPV (approximately 6.44V) and the reading on the current meter 52 data logging display was observed at screen 54 and verified as reading in the approximately 0.001 A to 0.002 A range (see FIG. 8), indicating a baseline current flowing through the limited conductivity of a fully developed and unperturbed BIL. This fully developed BIL is electrically insulating the wheel tool (Cathode) 12 from the blade blank work piece (Anode) 16.

Using the XY controllers (26, 28) on the micrometer 24, the work piece end 16a was slowly moved toward the spinning wheel 12 while assuring that the electrolyte 31 was wetting the wheel tool surface 12a at the location opposite the work piece end 16a. While advancing the work piece end 16a toward the spinning wheel surface 12a, the data logging current monitoring system 52 was monitored. As seen in FIG. 8, as the IEG 32 was closed to within about 10 microns, the BIL immediately adjacent to the blade blank end 16a was perturbed by the surface of the spinning tool 12a as evidenced by observing the machining current (on the data logging monitor) dramatically increase to a value of between 0.006 A to 0.010 A. The perturbation of the BIL was verified by temporarily moving the blade blank end 16a away from the spinning wheel 12 a further maximum of 10 microns, and observing the current drop to the 0.001 A to 0.002 A baseline current. This return to the baseline current was due to the reforming of the BIL (in approximately 100 to 2,000 milliseconds) which electrically insulated the blade blank end 16a from the spinning tool 12. Once this perturbation of the BIL immediately adjacent to the blade blank end 16a was verified in this manner, the IEG was narrowed by moving the blade blank end 16a back toward the wheel 12 to machine the end at the machining current starting at an approximate value of 0.006 A to 0.010 A. As material was machined away from the blade blank end 16a (approximately each 1 to 10 seconds) the measured DC current dropped off slightly, as indicated on the data logging monitor 52. At this time the IEG 32 was further narrowed by advancing the blade blank end 16a approximately 5 microns toward the spinning wheel 12, using the micrometer controls (26, 28). A narrow IEG was maintained to ensure that the BIL was continuously being perturbed. By repositioning the blade blank end 16a closer to the spinning wheel 12, the spinning wheel surface 12a was able to perturb the BIL resulting in an increase in current to the machining current indicating that full machining was restored. As machining progressed, both the baseline and machining currents gradually increased as the successfully machined surface area of the blade blank end 16a increased. As illustrated in FIG. 12b, for a given voltage, larger machined surface areas produce higher total gas production. Lower voltages should be used to machine these large surface areas to prevent generation of excessive gases which inhibit efficient machining (the Gas Entropy Effect). The blade blank end 16a being machined in this example is very small, thus a higher voltage may be used to successfully perturb the BIL with the spinning wheel surface 12a.

Once the blade blank end 16a was machined to the desired depth the controlled shutdown process of the inventive ECM system was initiated. First, the DC voltage was immediately turned off, and the blade blank 16 was quickly moved away from the spinning wheel 12. The spinning wheel 12 was turned off and then the electrolyte flow was turned off.

The blade blank 16 was then removed from the conductive work piece holder 20 and cleaned off to remove the previously applied coating 62 and plating materials 60. Cleaning of the end 16a can consist of cleaning sprays using electrolyte, deionized water, solvents or acid/base compounds of various mixtures and combinations for specific cleaning objectives. The machined blade blank 16 and machined end 16a was then examined under a microscope.

As seen in FIG. 7, the result was a well machined SiC surface, unaffected by excessive oxidation. This successful machining was due to a well controlled narrow IEG (about 0 to about 10 microns), abundant electrolyte, controlled voltage in the LMPV-HMPV range and a controlled shut-down process of the inventive ECM system. The randomly oriented SiC grain as pictured in FIG. 7 are in the 3 to 10 micron (length) range. The color of the grains is a function of the angle of the random SiC grain positioning. There is very little gas pitting and grain boundaries are tight with limited grain pullout.

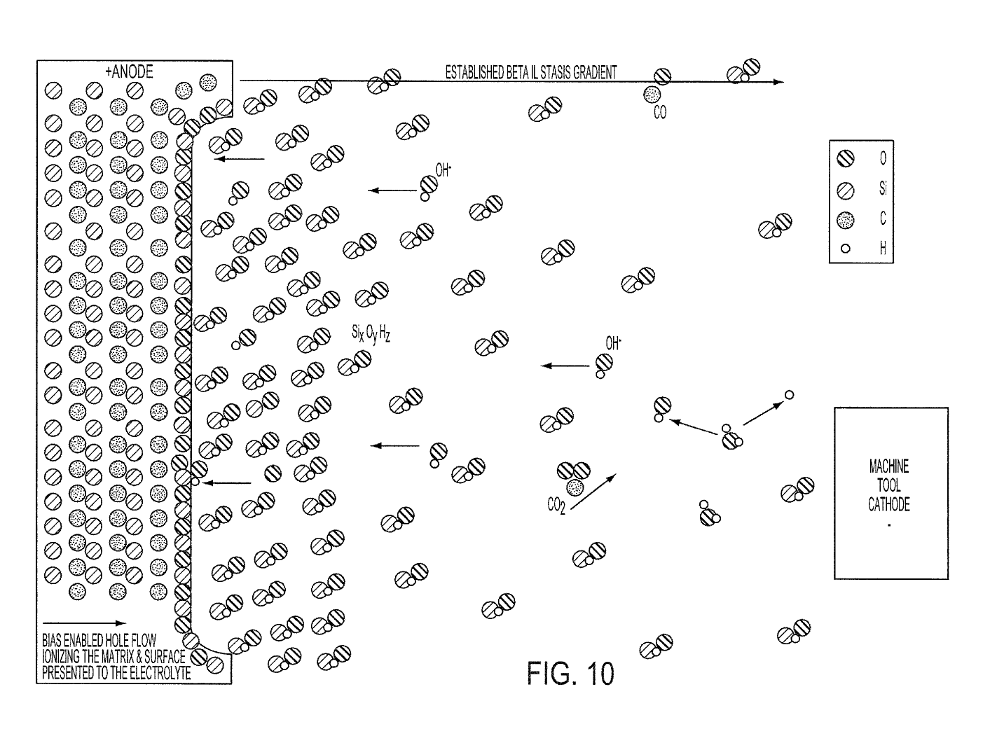

The surface is planar as verified by Scanning Electron Microscopy (SEM) and measurement of the surface smoothness using a mechanical profilometer. The machined surface of the blade blank end 16a, a portion of which is depicted in FIG. 7, measures about 100μ by about 1000μ. On a similarly colored surface, the profilometer data was given a value of 3.011.tin. Due to the small surface area of the machined surface, this profilometer measurement has limited accuracy as it is constrained by the sampling size of the machined blade blank end 16a and the limited ability to position the profilometer stylus in an area of the blade blank end 16a unaffected by imperfections in the machining tool surface (the unaffected portion of the blade blank end) used in this Example 1, a scored tool surface. In the preferred embodiment of this inventive ECM system, a perfectly planar tool surface 12a is used to machine a reflectively perfectly planar blade blank end surface 16a. Consequently, a better indicator of surface smoothness is depicted in the focused SEM photomicrograph (FIG. 11) indicating a more accurate surface smoothness measurement of the unaffected portion of the colorful blade blank end, a portion of which is depicted in FIG. 7, at −0.2 μin. The inventive ECM system, in its preferred embodiment, is capable of planar surface smoothness across the entirety of the machined surface area of +/−0.2 μin. Other methods may be used to measure surface smoothness such as a laser interferometer, for example.

The foregoing disclosure and description of the invention are illustrative and explanatory thereof, and various changes in the size, shape and materials, as well as in the details of the illustrated construction may be made without departing from the spirit of the invention.

1. A method of electrochemical machining comprising the steps of:
a) providing a work piece anode, a tool comprising a cathode, and an electrolytic fluid positioned between said cathode and said anode for continuous flushing of non-gaseous ionic byproducts during the machining process which form a Beta Insulating Layer (BIL) on said work piece;
b) applying a voltage selected to obtain a maximized current between said work piece and said cathode without initiating substantial hydrolysis of said electrolyte; and
c) perturbing and removing the BIL into solution.

2. The method of claim 1 wherein said work piece anode and said tool are spaced at a substantially constant distance of about from 0 to 10 μm apart during said machining process.

3-5. (canceled)

6. The method of claim 1 further comprising the step of perturbing the Beta Insulating Layer (BIL) by moving said tool.

7. The method of claim 6 wherein said BIL is perturbed by moving said tool at a rate of about 0.1 to about 80 Meters Per Second (MPS).

8. (canceled)

9. The method of claim 6 wherein said BIL is perturbed by moving said tool is perturbed at a rate of about 0.1 to about 20 MPS.

10. The method of claim 6 wherein said BIL is perturbed by moving said tool is perturbed at a rate of about 0.1 to about 1 MPS.

11. The method of claim 1 and further comprising the step of perturbing the Beta Insulating Layer by moving said work piece.

12. The method of claim 11 wherein said BIL is perturbed by moving said work piece at a rate of about 0.1 to about 80 MPS.

13. The method of claim 11 wherein said BIL is perturbed by moving said work piece at a rate of about 0.1 to about 40 MPS.

14. The method of claim 11 wherein said BIL is perturbed by moving said work piece at a rate of about 0.1 to about 20 MPS.

15. The method of claim 11 wherein said BIL is perturbed by moving said work piece at a rate of about 0.1 to about 1 MPS.

16. The method of claim 1 and further comprising applying a fugitive electrode to said work piece to reduce the work piece linear resistance.

17. The method of claim 16 wherein said linear resistance is reduced to between about 10 to 100 ohms.

18. The method of claim 1 and further comprising the step of applying an electrical passivation layer to areas of said work piece not to be machined.

19. A method for electrochemical machining of an electrically conductive work piece with a tool spaced from and defining an inter-electrode gap (IEG) therebetween, and an electrolyte directed through said IEG, wherein said machining produces non-gaseous, ionic byproducts of dissolution which form a Beta Insulating Layer on said work piece, said method comprising the steps of:
a) applying an incrementally increasing voltage between the work piece and tool starting from substantially zero volts;
b) monitoring the current generated between the work piece and tool;
c) observing a first value of the voltage upon sensing the onset of current, said first value defining the Low Machining Potential Voltage (LMPV);
d) while continuing to incrementally increase the voltage, observing a second value of the voltage upon sensing a decrease in said current, said second value occurring just prior to the onset of said current decrease, said second value defining the High Machining Potential Voltage (HMPV);
and e) electrochemically machining said work piece using a voltage maintained between said LMPV and HMPV.

20. The method of claim 19 and further comprising the step of decreasing said voltage in response to an increase in the surface area of said work piece during the machining process.

21. The method of claim 19 and further comprising the step of perturbing said Beta Insulating Layer by moving said tool or work piece during the machining process.

22. The method of claim 21 and further comprising the step of increasing the rate of tool motion in response to an increase in work piece surface area.

23. The method of claim 19 and further comprising the step of maintaining the IEG at between about 0 and 10 μm.

24. A method for electrochemical machining of an electrically conductive work piece, said method comprising the steps of:
a) providing a work piece comprising an anode, a tool comprising a cathode, and an electrolyte, said cathode positioned in spaced relation to said work piece and thereby defining the inter-electrode gap (IEG) with said electrolyte directed therebetween in a continuously flushing manner during the machining process wherein said machining produces non-gaseous, ionic by-products of dissolution which form a Beta Insulating Layer on said work piece;
b) applying a voltage between the work piece and cathode;
c) perturbing and removing the Beta Insulating Layer into solution with said electrolyte by moving one of said cathode and/or said work piece, said perturbing causing simultaneous pushing and pulling of said electrolyte into and out of an IEG maintained at between about 0 and 10 μm.
